(19) United States
(12) Patent Application Publication
(10) Pub. No.: US 2018/0359633 A1
(43) Pub. Date: Dec. 13, 2018

(54) Neighbor Awareness Networking Device Pairing

(71) Applicant: Apple Inc., Cupertino, CA (US)

(72) Inventors: Yong Liu, Campbell, CA (US); Christiaan A. Hartman, San Jose, CA (US); Guoqing Li, Cupertino, CA (US); Su Khiong Yong, Palo Alto, CA (US)

(21) Appl. No.: 16/005,271

(22) Filed: Jun. 11, 2018

Related U.S. Application Data
(60) Provisional application No. 62/518,336, filed on Jun. 12, 2017.

(51) Int. Cl. H04W 12/04; H04L 29/08; H04W 8/00; H04W 76/14; H04W 12/06

(52) U.S. Cl. CPC H04W 12/04; H04L 67/104; H04W 84/12; H04W 76/14; H04W 12/06; H04W 8/005

(57) ABSTRACT

One or more wireless stations may operate to configure direct communication with neighboring mobile stations, e.g., direct communication between the wireless stations without utilizing an intermediate access point. A mechanism for wireless stations to pair with neighboring wireless stations to establish secured data connections may include establishing a peer-to-peer data communication session, obtaining device pairing information via an out-of-band (OOB) mechanism, and exchanging device pairing information via transmission management frames to authenticate the peer device. A PTK based on the device pairing information may be installed to protect data frames exchanged at a MAC layer of the wireless station and a session key may be installed to protect data frames exchanged at higher layers.

### PRIORITY DATA

This application claims benefit of priority to U.S. Provisional Application Ser. No. 62/518,336, titled “Neighbor Awareness Networking Device Pairing”, filed Jun. 12, 2017, by Yong Liu, Christiaan A. Hartman, Guoqing Li, and Su Khiong Yong, which is hereby incorporated by reference in its entirety as though fully and completely set forth herein.

### FIELD

The present application relates to wireless communications, including techniques for wireless communication among wireless stations in a wireless networking system.

### DESCRIPTION OF THE RELATED ART

Wireless communication systems are rapidly growing in usage. Further, wireless communication technology has evolved from voice-only communications to also include the transmission of data, such as Internet and multimedia content. A popular short/intermediate range wireless communication standard is wireless local area network (WLAN). Most modern WLANs are based on the IEEE 802.11 standard (or 802.11, for short) and are marketed under the Wi-Fi brand name. WLAN networks link one or more devices to a wireless access point, which in turn provides connectivity to the wider area Internet.

In 802.11 systems, devices that wirelessly connect to each other are referred to as “stations”, “mobile stations”, “user devices” or STA or UE for short. Wireless stations can be either wireless access points or wireless clients (or mobile stations). Access points (APs), which are also referred to as wireless routers, act as base stations for the wireless network. APs transmit and receive radio frequency signals for communication with wireless client devices. APs can also typically couple to the Internet in a wired fashion. Wireless clients operating on an 802.11 network can be any of various devices such as laptops, tablet devices, smart phones, or fixed devices such as desktop computers. Wireless client devices are referred to herein as user equipment (or UE for short). Some wireless client devices are also collectively referred to herein as mobile devices or mobile stations (although, as noted above, wireless client devices overall may be stationary devices as well).

In some prior art systems, Wi-Fi mobile stations are able to communicate directly with each other without using an intermediate access point. However, improvements in the operation of such devices are desired, such as in the setup and coordination of the communication between such devices.

### SUMMARY

Some embodiments described herein relate to systems and methods for peer wireless stations (e.g., wireless stations configured to communicate with neighboring wireless stations without utilizing an intermediate access point) to trigger service discovery over a first interface via service advertisement over a second interface.

Some embodiments relate to a wireless station that includes one or more antennas, one or more radios, and one or more processors coupled (directly or indirectly) to the radios. At least one radio is configured to perform Wi-Fi communications, e.g., via a Wi-Fi interface. The wireless station may perform voice and/or data communications, as well as any or all of the methods described herein.

In some embodiments, one or more wireless stations operate to configure direct communication with one or more neighboring mobile stations, e.g., direct communication between the wireless stations without utilizing an intermediate access point. Embodiments of the disclosure relate to a mechanism for peer devices to pair with neighboring peer wireless stations.

In some embodiments, the communications may be performed via a peer-to-peer wireless communications protocol, such as Neighbor Awareness Networking (NAN). Thus, embodiments of the disclosure also relate to NAN devices exchanging signaling to pair with one another.

In some embodiments, a wireless station may be configured to establish, with a peer wireless station, a peer-to-peer data communication session via exchange of one or more service discovery frames and obtain device pairing information via an out-of-band (OOB) mechanism. The wireless station may be configured to exchange device pairing information with the peer wireless station via transmission of one or more management frames and authenticate the peer wireless station based on the exchange of device pairing information. Further, the wireless station may be configured to install a pairwise transient key (PTK) where the PTK may be based, at least in part, on the device pairing information and where the PTK may protect a data frame (and/or frames) exchanged at a MAC (Medium Access Control) layer of the wireless station. Additionally, the wireless station may be configured to install a session key, where the session key may be based, at least in part, on the device pairing information and where the session key may protect a data frame (and/or frames) exchanged at higher layers of the wireless station.

In some embodiments, the OOB mechanism may include at least one of a passcode input, a quick response (QR) code scan, and/or a near field communication (NFC) exchange. In some embodiments, the one or more management frames may include scheduling information and the scheduling information may be used for radio resource allocation. In some embodiments, the one or more management frames may be NAN action frames. In some embodiments, the device pairing information may include at least one of a shared secret, a shared key, and/or public keys.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example WLAN communication system, according to some embodiments.

FIG. 2 illustrates an example simplified block diagram of a WLAN Access Point (AP), according to some embodiments.

FIG. 3 illustrates an example simplified block diagram of a mobile station (UE), according to some embodiments.

FIG. 4A illustrates an example format of a synchronization/discovery beacon frame, according to some embodiments.

FIG. 4B illustrates an example format of a service discovery frame (SDF), according to some embodiments.

FIG. 4C illustrates an example format of a NAN attribute field, according to some embodiments,

FIG. 4D illustrates an example format of an action frame, according to some embodiments.

FIG. 5A illustrates an example of signaling between peer devices to establish security for a datapath.

FIG. 5B illustrates an example of security at various levels of communication for a datapath.

FIG. 6 illustrates an example of signaling between peer devices for device pairing, according to some embodiments.

FIG. 7 illustrates an example of signaling between peer devices for confirming device pairing, according to some embodiments.

FIG. 8 illustrates an example of signaling between peer devices for device pairing conducted at higher layers, according to some embodiments.

FIG. 9 illustrates a block diagram of an example of a method for peer device pairing, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present application. Definitions of the most prominently used acronyms that may appear throughout the present application are provided below:

UE: User Equipment

AP: Access Point

DL: Downlink (from BS to UE)

UL: Uplink (from UE to BS)

TX: Transmission/Transmit

RX: Reception/Receive

LAN: Local Area Network

WLAN: Wireless LAN

RAT: Radio Access Technology

DW: Discovery Window

NW: Negotiation Window

FAW: Further Availability Window

SID: Service ID

SInf: Service Information

SInf-Seg: Service Information Segment

NW-Req: to request the peer NAN device to present in NW

CaOp: Capabilities and Operations elements

Security: Security preferences

SessionInfo: advertisement_id, session_mac, session_id, port, proto

ChList: preferred datapath channels

AM: anchor master

DW: discovery window

HCFR: hop count from remote devices

NAN: neighbor awareness network

SDA: service descriptor attribute

SDF: service discovery frame

SRF: service response filter

TSF: time synchronization function

### Terminology

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Mobile Device (or Mobile Station)—any of various types of computer systems devices which are mobile or portable and which performs wireless communications using WLAN communication. Examples of mobile devices include mobile telephones or smart phones (e.g., iPhone™, Android™-based phones), and tablet computers such as iPad™, Samsung Galaxy™ etc. Various other types of devices would fall into this category if they include Wi-Fi or both cellular and Wi-Fi communication capabilities, such as laptop computers (e.g., MacBook™) portable gaming devices (e.g., Nintendo DS™, PlayStation Portable™, Gameboy Advance™, iPhone™), portable Internet devices, and other handheld devices, as well as wearable devices such as smart watches, smart glasses, headphones, pendants, earpieces, etc. In general, the term “mobile device” can be broadly defined to encompass any electronic, computing, and/or telecommunications device (or combination of devices) which is easily transported by a user and capable of wireless communication using WLAN or Wi-Fi.

Wireless Device (or Wireless Station)—any of various types of computer systems devices which performs wireless communications using WLAN communications. As used herein, the term “wireless device” may refer to a mobile device, as defined above, or to a stationary device, such as a stationary wireless client or a wireless base station. For example, a wireless device may be any type of wireless station of an 802.11 system, such as an access point (AP) or a client station (STA or UE). Further examples include televisions, media players (e.g., AppleTV™, Roku™ Amazon FireTV™, Google Chromecast™, etc.), refrigerators, laundry machines, thermostats, and so forth.

WLAN—The term “WLAN” has the full breadth of its ordinary meaning, and at least includes a wireless communication network or RAT that is serviced by WLAN access points and which provides connectivity through these access points to the Internet. Most modern WLANs are based on IEEE 802.11 standards and are marketed under the name “Wi-Fi”. A WLAN network is different from a cellular network.

Processing Element—refers to various implementations of digital circuitry that perform a function in a computer system. Additionally, processing element may refer to various implementations of analog or mixed-signal (combination of analog and digital) circuitry that perform a function (or functions) in a computer or computer system. Processing elements include, for example, circuits such as an integrated circuit (IC), ASIC (Application Specific Integrated Circuit), portions or circuits of individual processor cores, entire processor cores, individual processors, programmable hardware devices such as a field programmable gate array (FPGA), and/or larger portions of systems that include multiple processors.

NAN data link (NDL)—refers to a communication link between peer wireless stations (e.g., peer NAN devices). Note that the peer devices may be in a common (e.g., same) NAN cluster. In addition, a NAN data link may support one or more NAN datapaths between peer wireless stations. Note further that a NAN data link may only belong to a single NAN data cluster.

NAN datapath (NDP)—refers to a communication link between peer wireless stations that supports a service. Note that one or more NAN datapaths may be supported by a NAN data link. Additionally, note that a NAN datapath supports a service between wireless stations. Typically, one of the peer wireless stations will be a publisher of the service and the other peer wireless station will be a subscriber to the service.

NAN cluster—refers to multiple peer wireless stations linked via synchronization to a common time source (e.g., a common NAN clock). Note that a peer wireless station may be a member of more than one NAN cluster.

NAN data cluster (NDC)—refers to a set of peer wireless stations in a common (e.g., same) NAN cluster that share a common base schedule (e.g., a NAN data cluster base schedule). In addition, peer wireless stations in a NAN data cluster may share at least one NAN data link that includes an active datapath with another member wireless station within the NAN data cluster.

Note that a peer wireless station may be a member of more than one NAN cluster; however, as noted previously, a NAN data link belongs to exactly one NAN data cluster. Note further, that in a NAN data cluster, all member peer wireless stations may maintain tight synchronization (e.g., via a NAN data cluster base schedule) amongst each other and may be present at a common (e.g., same) further availability slot(s) (or window(s)) as indicated by a NAN data cluster base schedule. In addition, each NAN data link may have its own NAN data link schedule and the NAN data link schedule may be a superset of a NAN data cluster base schedule.

WI-FI—The term “WI-FI” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “WI-FI”. A WI-FI (WLAN) network is different from a cellular network.

BLUETOOTH™—The term “BLUETOOTH™” has the full breadth of its ordinary meaning, and at least includes any of the various implementations of the Bluetooth standard, including Bluetooth Low Energy (BTLE) and Bluetooth Low Energy for Audio (BTLEA), including future implementations of the Bluetooth standard, among others.

Personal Area Network—The term “Personal Area Network” has the full breadth of its ordinary meaning, and at least includes any of various types of computer networks used for data transmission among devices such as computers, phones, tablets and input/output devices. Bluetooth is one example of a personal area network. A PAN is an example of a short range wireless communication technology.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, e.g., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Concurrent—refers to parallel execution or performance, where tasks, processes, signaling, messaging, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

The headings used herein are for organizational purposes only and are not meant to be used to limit the scope of the description. As used throughout this application, the word “may” is used in a permissive sense (e.g., meaning having the potential to), rather than the mandatory sense (e.g., meaning must). The words “include,” “including,” and “includes” indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated. For example, a “third component electrically connected to the module substrate” does not preclude scenarios in which a “fourth component electrically connected to the module substrate” is connected prior to the third component, unless otherwise specified. Similarly, a “second” feature does not require that a “first” feature be implemented prior to the “second” feature, unless otherwise specified.

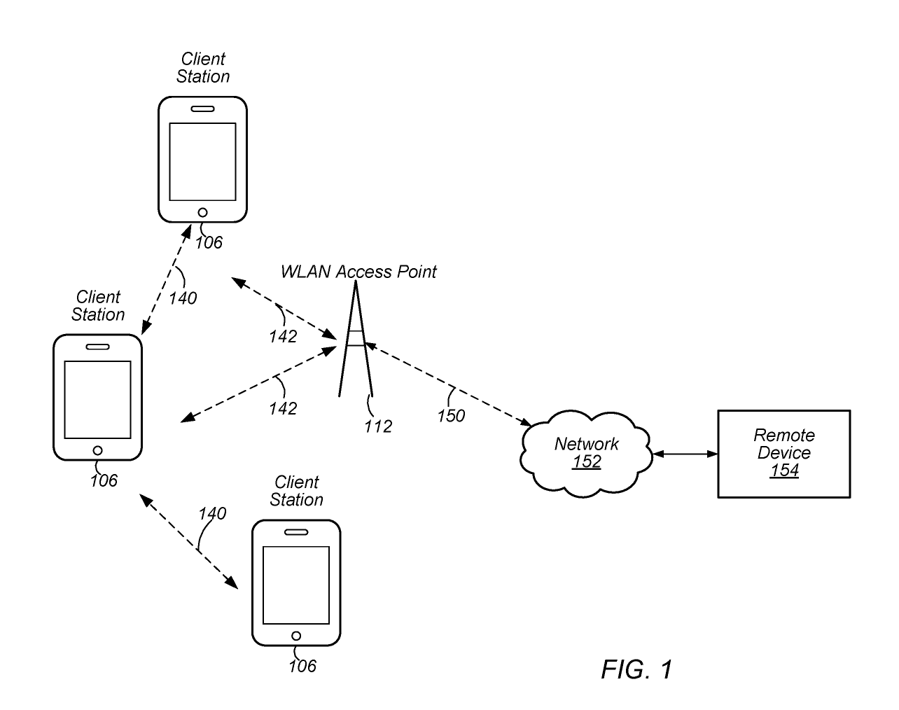

### FIG. 1—WLAN System

FIG. 1 illustrates an example WLAN system according to some embodiments. As shown, the exemplary WLAN system includes a plurality of wireless client stations or devices, or user equipment (UEs), 106 that are configured to communicate over a wireless communication channel 142 with an Access Point (AP) 112. The AP 112 may be a Wi-Fi access point. The AP 112 may communicate via a wired and/or a wireless communication channel 150 with one or more other electronic devices (not shown) and/or another network 152, such as the Internet. Additional electronic devices, such as the remote device 154, may communicate with components of the WLAN system via the network 152. For example, the remote device 154 may be another wireless client station. The WLAN system may be configured to operate according to any of various communications standards, such as the various IEEE 802.11 standards. In some embodiments, at least one wireless device 106 is configured to communicate directly with one or more neighboring mobile devices (e.g., via direct communication channels 140), without use of the access point 112.

In some embodiments, as further described below, a wireless device 106 may be configured to perform methods to establish, with a peer wireless device, a peer-to-peer data communication session via exchange of one or more service discovery frames and obtain device pairing information via an out-of-band (OOB) mechanism. The wireless device 106 may be configured to exchange device pairing information with the peer wireless device via transmission of one or more management frames and authenticate the peer wireless device based on the exchange of device pairing information. Further, the wireless device 106 may be configured to install a pairwise transient key (PTK) where the PTK may be based, at least in part, on the device pairing information and where the PTK may protect a data frame (and/or frames) exchanged at a MAC layer of the wireless device 106. Additionally, the wireless device 106 may be configured to install a session key, where the session key may be based, at least in part, on the device pairing information and where the session key may protect a data frame (and/or frames) exchanged at higher layers of the wireless device 106.

In some embodiments, the OOB mechanism may include at least one of a passcode input, a quick response (QR) code scan, and/or a near field communication (NFC) exchange. In some embodiments, the one or more management frames may include scheduling information and the scheduling information may be used for radio resource allocation. In some embodiments, the one or more management frames may be NAN action frames. In some embodiments, the device pairing information may include at least one of a shared secret, a shared key, and/or public keys.

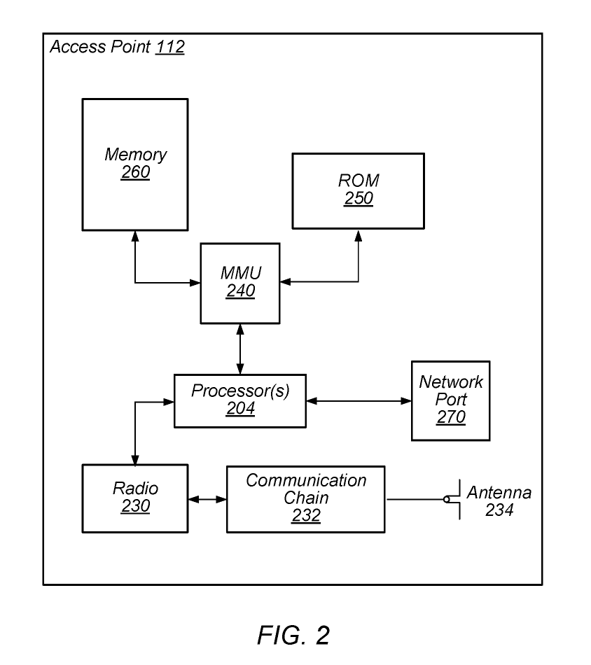

### FIG. 2—Access Point Block Diagram

FIG. 2 illustrates an exemplary block diagram of an access point (AP) 112. It is noted that the block diagram of the AP of FIG. 2 is only one example of a possible system. As shown, the AP 112 may include processor(s) 204 that may execute program instructions for the AP 112. The processor(s) 204 may also be coupled (directly or indirectly) to memory management unit (MMU) 240, which may be configured to receive addresses from the processor(s) 204 and to translate those addresses to locations in memory (e.g., memory 260 and read only memory (ROM) 250) or to other circuits or devices.

The AP 112 may include at least one network port 270. The network port 270 may be configured to couple to a wired network and provide a plurality of devices, such as mobile devices 106, access to the Internet. For example, the network port 270 (or an additional network port) may be configured to couple to a local network, such as a home network or an enterprise network. For example, port 270 may be an Ethernet port. The local network may provide connectivity to additional networks, such as the Internet.

The AP 112 may include at least one antenna 234, which may be configured to operate as a wireless transceiver and may be further configured to communicate with mobile device 106 via wireless communication circuitry 230. The antenna 234 communicates with the wireless communication circuitry 230 via communication chain 232. Communication chain 232 may include one or more receive chains, one or more transmit chains or both. The wireless communication circuitry 230 may be configured to communicate via Wi-Fi or WLAN, e.g., 802.11. The wireless communication circuitry 230 may also, or alternatively, be configured to communicate via various other wireless communication technologies, including, but not limited to, Long-Term Evolution (LTE), LTE Advanced (LTE-A), Global System for Mobile (GSM), Wideband Code Division Multiple Access (WCDMA), CDMA2000, etc., for example when the AP is co-located with a base station in case of a small cell, or in other instances when it may be desirable for the AP 112 to communicate via various different wireless communication technologies.

In some embodiments, as further described below, AP 112 may be configured to perform methods establish, with a peer wireless station, a peer-to-peer data communication session via exchange of one or more service discovery frames and obtain device pairing information via an out-of-band (OOB) mechanism. The AP 112 may be configured to exchange device pairing information with the peer wireless station via transmission of one or more management frames and authenticate the peer wireless station based on the exchange of device pairing information. Further, the AP 112 may be configured to install a pairwise transient key (PTK) where the PTK may be based, at least in part, on the device pairing information and where the PTK may protect a data frame (and/or frames) exchanged at a MAC layer of the AP 112. Additionally, the AP 112 may be configured to install a session key, where the session key may be based, at least in part, on the device pairing information and where the session key may protect a data frame (and/or frames) exchanged at higher layers of the AP 112.

In some embodiments, the OOB mechanism may include at least one of a passcode input, a quick response (QR) code scan, and/or a near field communication (NFC) exchange. In some embodiments, the one or more management frames may include scheduling information and the scheduling information may be used for radio resource allocation. In some embodiments, the one or more management frames may be NAN action frames. In some embodiments, the device pairing information may include at least one of a shared secret, a shared key, and/or public keys.

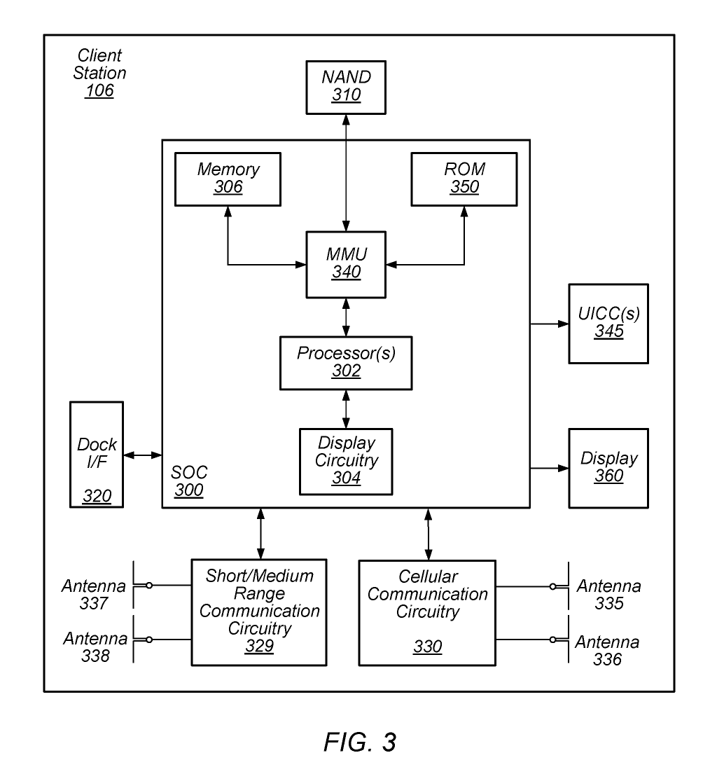

### FIG. 3—Client Station Block Diagram

FIG. 3 illustrates an example simplified block diagram of a client station 106. It is noted that the block diagram of the client station of FIG. 3 is only one example of a possible client station. According to embodiments, client station 106 may be a user equipment (UE) device, a mobile device or mobile station, and/or a wireless device or wireless station. As shown, the client station 106 may include a system on chip (SOC) 300, which may include portions for various purposes. The SOC 300 may be coupled to various other circuits of the client station 106. For example, the client station 106 may include various types of memory (e.g., including NAND flash 310), a connector interface (I/F) (or dock) 320 (e.g., for coupling to a computer system, dock, charging station, etc.), the display 360, cellular communication circuitry 330 such as for LTE, GSM, etc., and short to medium range wireless communication circuitry 329 (e.g., Bluetooth™ and WLAN circuitry). The client station 106 may further include one or more smart cards 310 that incorporate SIM (Subscriber Identity Module) functionality, such as one or more UICC(s) (Universal Integrated Circuit Card(s)) cards 345. The cellular communication circuitry 330 may couple to one or more antennas, such as antennas 335 and 336 as shown. The short to medium range wireless communication circuitry 329 may also couple to one or more antennas, such as antennas 337 and 338 as shown. Alternatively, the short to medium range wireless communication circuitry 329 may couple to the antennas 335 and 336 in addition to, or instead of, coupling to the antennas 337 and 338. The short to medium range wireless communication circuitry 329 may include multiple receive chains and/or multiple transmit chains for receiving and/or transmitting multiple spatial streams, such as in a multiple-input multiple output (MIMO) configuration.

As shown, the SOC 300 may include processor(s) 302, which may execute program instructions for the client station 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, cellular communication circuitry 330, short range wireless communication circuitry 329, connector interface (I/F) 320, and/or display 360. The MMU 340 may be configured to perform memory protection and page table translation or set up. In some embodiments, the MMU 340 may be included as a portion of the processor(s) 302.

As noted above, the client station 106 may be configured to communicate wirelessly directly with one or more neighboring client stations. The client station 106 may be configured to communicate according to a WLAN RAT for communication in a WLAN network, such as that shown in FIG. 1. Further, in some embodiments, as further described below, client station 106 may be configured to perform methods to establish, with a peer client station, a peer-to-peer data communication session via exchange of one or more service discovery frames and obtain device pairing information via an out-of-band (OOB) mechanism. The client station 106 may be configured to exchange device pairing information with the peer client station via transmission of one or more management frames and authenticate the peer client station based on the exchange of device pairing information. Further, the client station 106 may be configured to install a pairwise transient key (PTK) where the PTK may be based, at least in part, on the device pairing information and where the PTK may protect a data frame (and/or frames) exchanged at a MAC layer of the client station 106. Additionally, the client station 106 may be configured to install a session key, where the session key may be based, at least in part, on the device pairing information and where the session key may protect a data frame (and/or frames) exchanged at higher layers of the client station 106.

In some embodiments, the OOB mechanism may include at least one of a passcode input, a quick response (QR) code scan, and/or a near field communication (NFC) exchange. In some embodiments, the one or more management frames may include scheduling information and the scheduling information may be used for radio resource allocation. In some embodiments, the one or more management frames may be NAN action frames. In some embodiments, the device pairing information may include at least one of a shared secret, a shared key, and/or public keys.

As described herein, the client station 106 may include hardware and software components for implementing the features described herein. For example, the processor 302 of the client station 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the UE 106, in conjunction with one or more of the other components 300, 304, 306, 310, 320, 330, 335, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 204.

Further, as described herein, cellular communication circuitry 330 and short range wireless communication circuitry 329 may each include one or more processing elements. In other words, one or more processing elements may be included in cellular communication circuitry 330 and also in short range wireless communication circuitry 329. Thus, each of cellular communication circuitry 330 and short range wireless communication circuitry 329 may include one or more integrated circuits (ICs) that are configured to perform the functions of cellular communication circuitry 330 and short range wireless communication circuitry 329, respectively. In addition, each integrated circuit may include circuitry (e.g., first circuitry, second circuitry, etc.) configured to perform the functions of cellular communication circuitry 330 and short range wireless communication circuitry 329.

### Peer-to-Peer Frame Formats

In some embodiments, Wi-Fi devices (e.g., client station 106) may be able to communicate with each other in a peer to peer manner, e.g., without the communications going through an intervening access point. In some embodiments, devices may exchange one or more management frames, e.g., such as synchronization/discovery beacon frames, service discovery frames (SDFs), and/or action frames, in order to synchronize, advertise, solicit, and/or negotiate a peer-to-peer data session, such as a NAN datapath and/or a NAN datalink. In some embodiments, particular management frame formats (e.g., synchronization/discovery beacon frame formats, SDF formats, and/or action frame formats) may be implemented to transport information associated with embodiments disclosed herein.

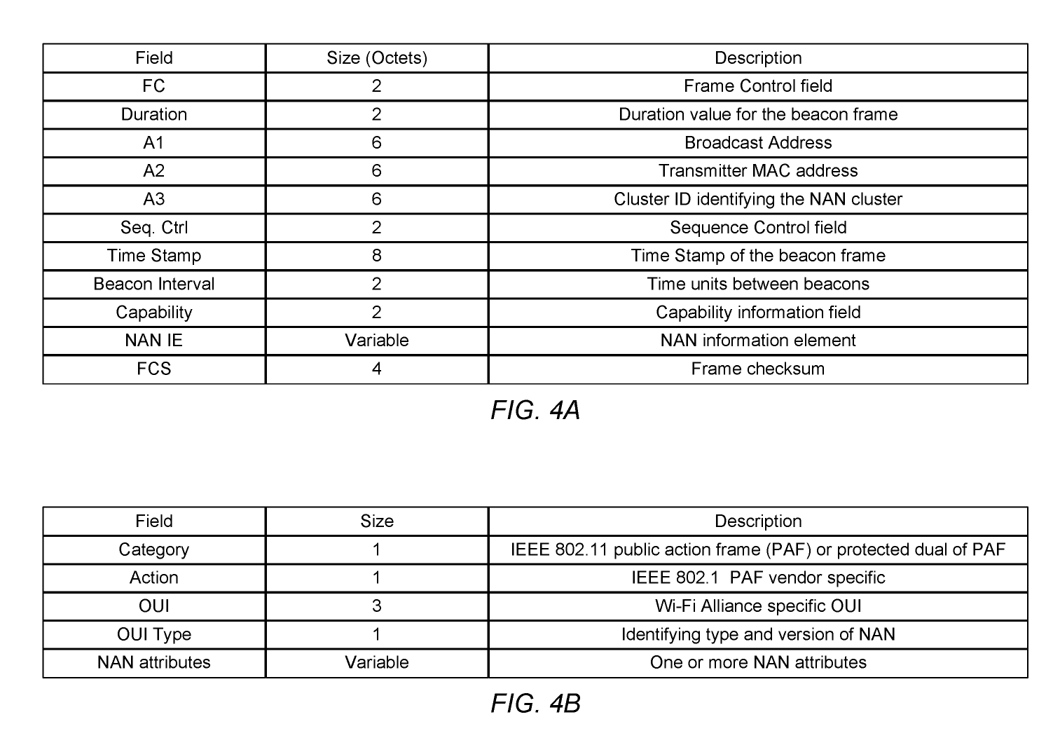

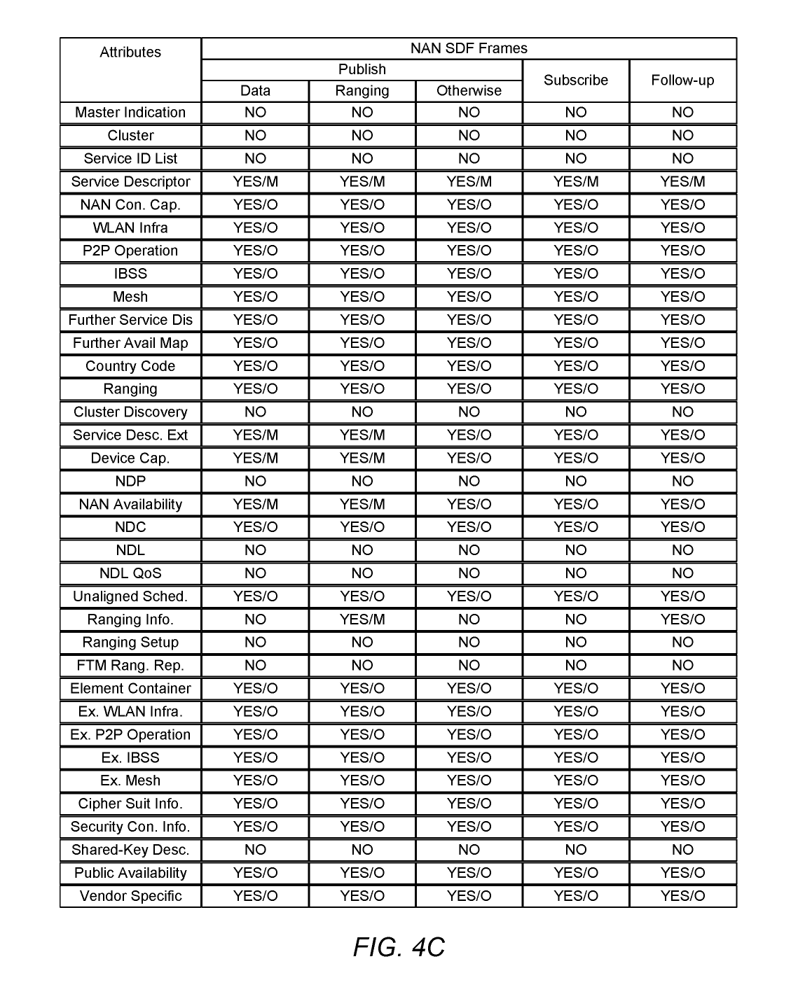

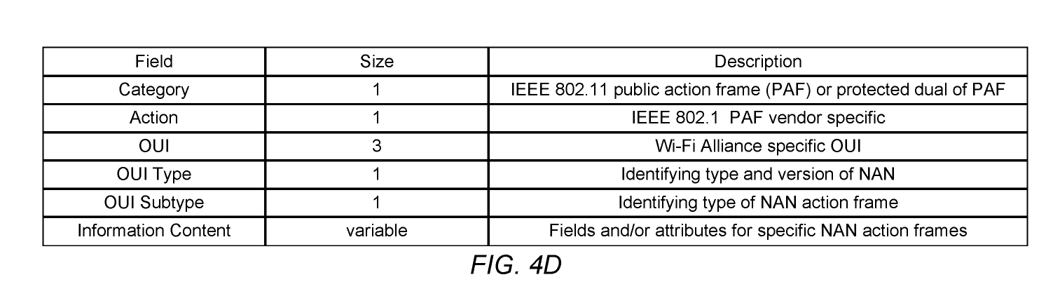

For example, as illustrated by FIG. 4A, a synchronization/discovery beacon frame format (e.g., as specified by NAN 2.0) may include fields such as a frame control (FC) filed, a duration field, multiple address fields (e.g., A1-A3), a sequence control field, a time stamp field, a beacon interval field, a capability information field, a NAN information element (IE) field, and/or a frame checksum (FCS) field. The frame control field, duration field, sequence control field, time stamp field, beacon interval field, capability field, and FCS field may be defined by IEEE 802.11. Note that for synchronization beacons, the beacon interval field may be set to 512 TUs, which may correspond to a time interval between consecutive starts of discovery windows. In addition, for discovery beacons, the beacon interval field may be set to 100 TUs, which may correspond to an average time between consecutive discovery beacon transmissions by a device in a master role. Addresses may include a broadcast address (A1), a transmitter medium access control (MAC) address (A2), and a cluster identifier address (A3). In some embodiments, the NAN IE may be vendor specific and may be configured to transport information associated with embodiments disclosed herein.

As another example, as illustrated by FIG. 4B, a service discovery frame format (e.g., as specified by NAN 2.0) may include one or more fields, including a category field, an action field, an organizationally unique identifier (OUI) field, an OUI type field, and/or a NAN attributes field. In some embodiments, information associated with embodiments disclosed herein may be transported via the NAN attributes field. In some embodiments, information associated with embodiments disclosed herein may be transported via the OUI field and/or the OUI type field.

Further, as illustrated by FIG. 4C, the NAN attribute field (e.g., as specified by NAN 2.0) includes multiple fields that may be used to implement features of embodiments disclosed herein. For example, in some embodiments, information associated with embodiments disclosed herein may be transported via any of (or any combination of) attributes included in the NAN attribute field. For example, in some embodiments, the vendor specific attribute may be used to transport information associated with embodiments disclosed herein. As another example, the further availability map attribute may be used to transport information associated with embodiments disclosed herein. As shown, the NAN attribute field may contain (or included) different attributes based on a type of NAN SDF frame. For example, a publish SDF frame for data transmission may include both mandatory (M) and optional (O) attributes that differ from a publish SDF frame for ranging and/or other purposes (e.g., “Otherwise”). Similarly, a subscribe SDF frame may include differing attributes as compared to a follow-up SDF and/or the various publish SDF frames. Thus, as a further example, various configurations of a NAN attribute may be used to transport information associated with embodiments disclosed herein.

As yet a further example, as illustrated by FIG. 4D, an action frame format (e.g., as specified by NAN 2.0) may include one or more fields, including a category field, an action field, an OUI field, an OUI type field, an OUI subtype field and/or an information content field. In some embodiments, information associated with embodiments disclosed herein may be transported via the information content field. In some embodiments, information associated with embodiments disclosed herein may be transported via the OUI field, the OUI type field, and/or the OUI subtype field.

### Wi-Fi Peer to Peer Communication Protocols

In some embodiments, Wi-Fi devices (e.g., client station 106) may be able to communicate with each other in a peer to peer manner, e.g., without the communications going through an intervening access point. There are currently two types of Wi-Fi peer to peer networking protocols in the Wi-Fi Alliance. In one type of peer to peer protocol, when two Wi-Fi devices (e.g., wireless stations) communicate with each other, one of the Wi-Fi devices essentially acts as a pseudo access point and the other acts as a client device. In a second type of Wi-Fi peer to peer protocol, referred to as a neighbor awareness networking (NAN), the two Wi-Fi client devices (wireless stations) act as similar peer devices in communicating with each other, e.g., neither one behaves as an access point.

In a NAN system, each wireless station may implement methods to ensure that it is synchronized with a neighboring wireless station to which it is communicating. Further, a wireless station may negotiate a common discovery window for exchange of synchronization packets to help ensure the devices that are communicating directly with each other are properly synchronized to enable the communication. Once two wireless stations have the same discovery window they may exchange synchronization packets to stay synchronized with each other. The wireless stations may also use the discovery window to exchange service discovery frames to convey other information such as further availability beyond discovery windows.

The NAN protocol includes two aspects: 1) synchronization and discovery (NAN 1.0) and 2) datapath transmission (NAN 2.0). The NAN protocol also may incorporate additional aspects. NAN 1.0 describes methods for NAN protocol synchronization and discovery. After two wireless stations have discovered each other (per NAN 1.0) they may implement a procedure to setup a NAN datapath between them so that they can communicate. After this, the two wireless stations arrange for a common datapath negotiation window so that they can negotiate capabilities, synchronization requirements, and/or exchange further service information (e.g., per NAN 2.0). The datapath negotiation window is a time window that enables two wireless stations to communicate with each other so that they can negotiate capabilities and/or synchronization requirements, and exchange further service information. Once the datapath negotiation window has been established and NAN datapath setup has been performed, the wireless stations may perform datapath synchronization to help ensure that the two stations stay synchronized with each other for communication. Finally, datapath resource allocation relates to two peer wireless stations communicating with each other regarding a common time slot and channel for communication. In other words, the two devices communicate with each other regarding which channel they should use and at which time slot, to help ensure proper communication between them. Additionally, the two devices communicate with each other regarding which channel and time slot each would prefer to use for future communications between the devices.

Embodiments described herein further define methods (and/or mechanisms) for a wireless station (including, but not limited to, a NAN device) to pair with a neighboring wireless station.

### Peer-to-Peer Device Pairing

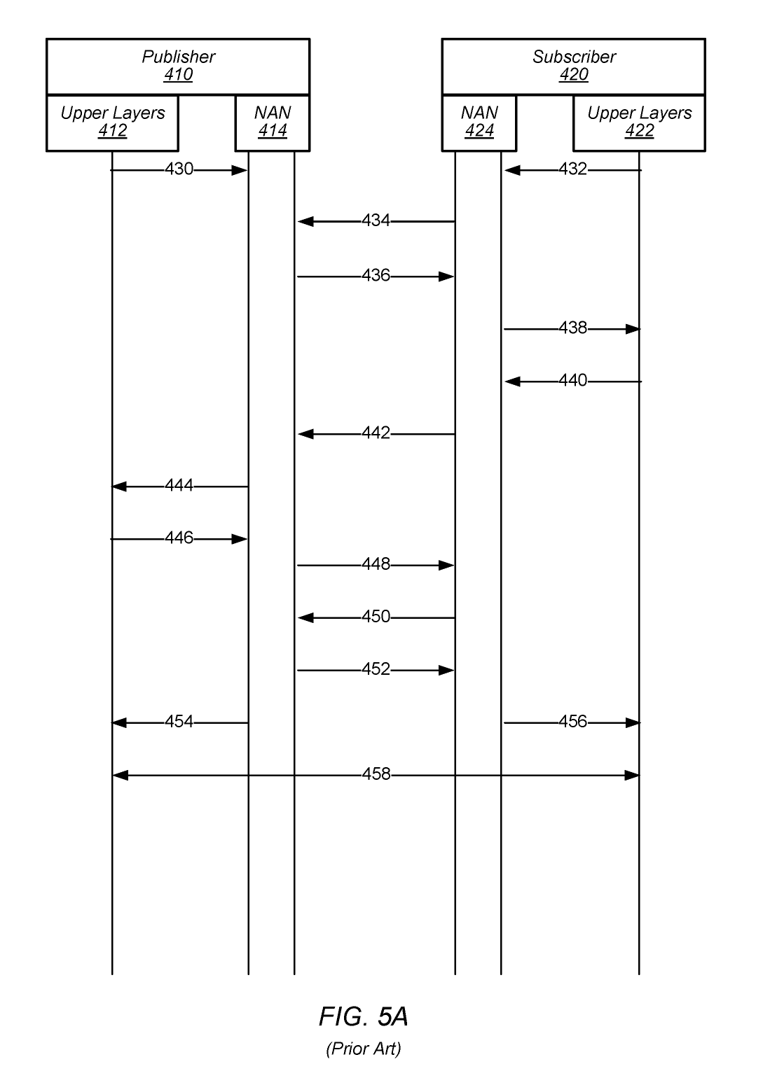

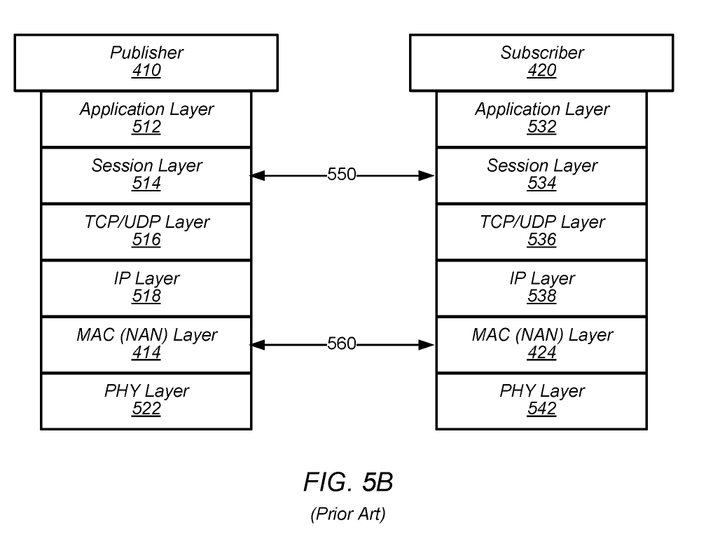

In some implementations, peer (or neighboring) wireless stations may use a shared-key based secured NAN datapath (NDP) protocol to establish security for the datapath. For example, as illustrated FIG. 5A, a subscribing device (e.g., subscriber 420) may transmit a subscribe request 434 (e.g., a subscribe service discovery frame (SDF), which may be initiated by a message 432 from upper layers 422 to NAN layer 424) to a publishing device (e.g., publisher 410) seeking subscription to a service. The publishing device 410 may have previously published the service, e.g., the publishing of the service may have been initiated by upper layers 412 of publishing device 410 via message 430 to NAN layer 414 of publishing device 410. The publishing device 410 may respond with a publish SDF 436 that includes cipher suite identifiers (CSIDs) and/or security context identifiers (SCIDs). The subscribing device 420 may receive the publish SDF 436 (including any included CSIDs and/or SCIDs) at a NAN layer 424 and pass content (e.g., via message 438) of the publish SDF 436 (e.g., any included CSIDs and/or SCIDs) to upper layers 422. The upper layers 422 may respond by passing a CSID, SCID, and a pairwise master key (PMK) (e.g., via message 440) back to the NAN layer 424 which may then include the CSID and SCID along with a key descriptor (which contains key related information) in a NAN datapath (NDP) request 442 to the publishing device 410. The NAN layer 414 of the publishing device 410 may receive the NDP 442 request and pass it (e.g., via message 444) to upper layers 412 of the publishing device 410. The upper layers 412 may respond (e.g., via message 446) to the NAN layer 414 with the SCID and PMK (e.g., as included in message 446). The NAN layer 414 of the publishing device 410 may then transmit a NDP response 448 which includes the CSID, SCID, and key descriptor (e.g., including encrypted data). The NAN layer 424 of the subscribing device 420 may then receive the NDP response 448 and may confirm NDP security (e.g., via an NDP security confirmation message 450 that includes the key descriptor and encrypted data, which may be then be confirmed by NAN layer 414 via response message 452 to NAN layer 424). At this point the NPD security may be considered setup and/or installed (and NAN layers 414 and 424 may notify upper layers 412 and 422, respectively, via messages 454 and 456) and secured data communications 458 may commence between upper layers of the devices. In other words, the devices may use a 4-way handshake to verify the PMK and install a pairwise transient key (PTK).

However, it should be noted that long-term shared PMKs may suffer from weak perfect forward secrecy. In other words, PMKs may be deciphered over time and prior data transmissions captured by third parties (e.g., devices not involved in the secured data communications) may then be unencrypted. In addition, if PMKs are derived by using a static pass-phrase, PMKs may also be susceptible to brute-force key space search attacks (e.g., an attacker may systematically attempt all possible pass-phrases until the PMK is discovered or an attacker may attempt to decipher the PMK using a key derivation function.

FIG. 5 illustrates an example of security at various levels of communication for a datapath established between publishing device 410 and subscribing device 420, according to some implementations. As shown, each device may include multiple layers for communication (e.g., each device may include a protocol stack for peer-to-peer communications). Thus, publishing device 410 may include an application layer 512, a session layer 514, a TCP/UDP layer 516, an IP layer 518, a MAC (or NAN) layer 414, and a physical layer 522. Note that some or all layers “above” MAC layer 414 (e.g., application layer 512, session layer 514, TCP/UDP layer 516 and/or IP layer 518) may be considered upper layers and may be comprised in upper layers 412 as described in reference to FIG. 5A. Similarly, subscribing device 420 may include an application layer 532, a session layer 534, a TCP/UDP layer 536, an IP layer 538, a MAC (or NAN) layer 424, and a physical layer 542. Note that some or all layers “above” MAC layer 424 (e.g., application layer 532, session layer 534, TCP/UDP layer 536 and/or IP layer 538) may be considered upper layers and may be comprised in upper layers 422 as described in reference to FIG. 5A. As shown, peer-to-peer security may be provided at a medium access control (MAC) (or NAN) level via a secured NAN datapath (e.g., connection 560 between MAC layers 414 and 424), e.g., as described above. In addition, end-to-end security may be provided at a session layer (e.g., connection 550 between session layers 514 and 534) and may disregard possible changes of lower layer communications (e.g., a change from peer-to-peer direct communication to remote communication via the Internet). In some implementations, services may choose to use MAC layer peer-to-peer security only, session layer end-to-end security only, and/or both peer-to-peer and end-to-end security. Note that both MAC layer and session layer security may require peer-to-peer authentication such as password/passcode verification, quick response (QR) code scanning, and/or near field communication (NFC) bootstrapping. Thus, in some implementations, multiple authentications (e.g., for MAC layer and/or session layer security) may be required.

In some embodiments, pairing bootstrapping (or device pairing) between (or amongst) peer devices (e.g., such as client stations 106) may occur (or happen) before, during, and/or post (after) NAN service discovery and/or pairing bootstrapping between peer devices may replace NAN service discovery. In some embodiments, pairing bootstrapping may require user involvement such as when a user discovers a device/service. In some embodiments, device pairing (or pairing bootstrapping) may be based, at least in part, on a password-authenticated key exchange (or agreement) (PAKE) method (protocol). For example, a shared password may be provisioned via an out-of-band (OOB) mechanism such as inputting (e.g., via a user interface) a passcode, scanning a QR code, using NFC, and so forth. Note that OOB data (e.g., such as the passcode, QR code, and so forth) may be considered as data that is transferred through a stream that is independent from a main in-band data stream. Thus, an OOB data mechanism may provide a conceptually independent channel that may allow any data sent via the OOB data mechanism to be kept separate from in-band data (e.g., such as data transmitted over a NAN datapath). In some embodiments, completion of device pairing (or pairing bootstrapping) may install a shared secret (or key) between the peer devices and/or may install authenticated public keys from the peer devices.

Note that in some embodiments, device pairing messages may be transmitted (or carried) in management frames along with scheduling information, e.g., to ensure sufficient radio resource allocation for the device pairing. In some embodiments, the management frames may be NAN action frames (NAFs), e.g., frames which trigger an action or response from a receiver of the frames. In some embodiments, the radio resource allocation may include resource allocations for device pairing handshaking (message exchanges) and/or subsequent security setup handshaking.

In some embodiments, secured datapath setup and/or secured session setup may use the shared secret (or key) and/or authenticated public keys obtained during device pairing. For example, the peer devices may use the shared secret (or key) obtained in the device pairing as a long-term PMK and/or the peer devices may derive a long-term PMK based on the shared secret (or key). Further, the shared-key based secured datapath protocol may then be used to verify a PMK and install a PTK. As another example, an authenticated public key obtained during device pairing may be used as a long-term public key and/or the peer devices may derive long-term public keys based on the authenticated public key. Further, a Diffie-Hellman method may be then used to derive and install a PTK.

In some embodiments, the PTK may be used to protect all MAC level data frames exchanged between the peer devices. In addition, in some embodiments, secured datapath setup messages may be carried in management frames such as action frames.

In some embodiments, secured session setup may include using the authenticated public keys obtained during device pairing as long-term public keys and/or to derive long-term public keys. Then, a Diffie-Hellman method may be used to derive and install a session key. In some embodiments, the session key may be used to protect all data frames exchanged at higher layers for the session (e.g., at a service or application layer). In some embodiments, secured session setup messages may be carried via NAN management frames, such as NAN action frames, and/or in higher layer frames, such as HTTP frames.

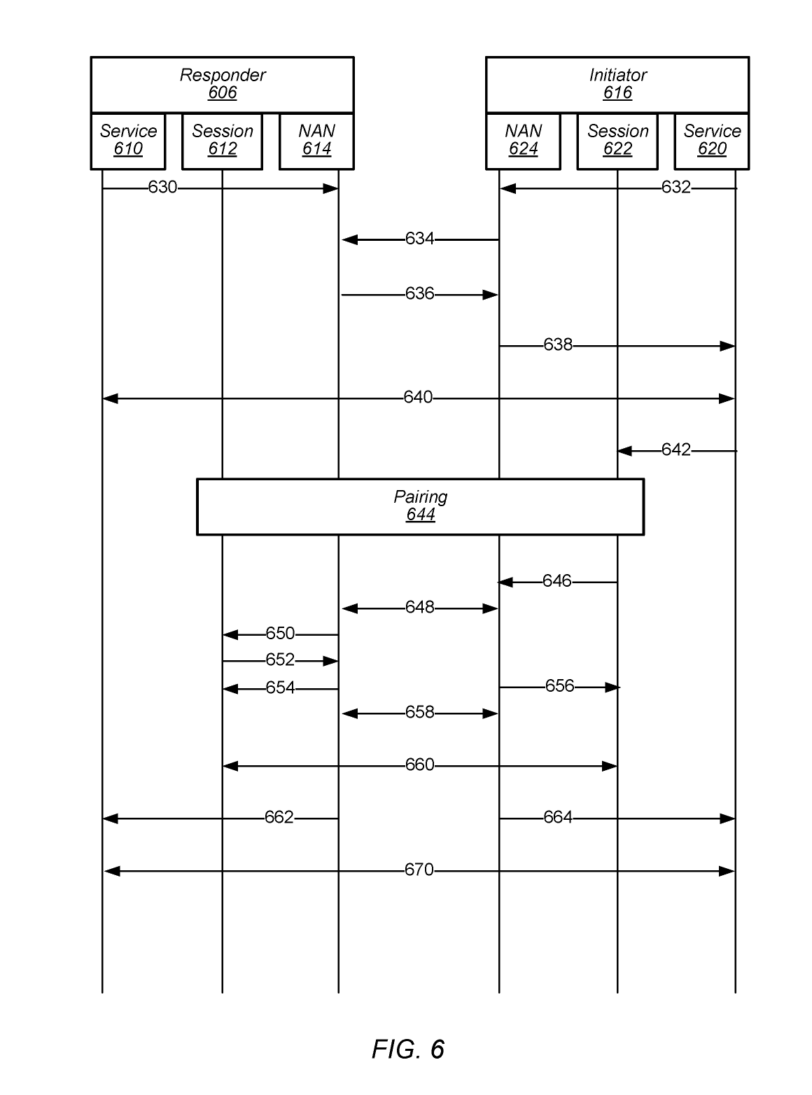

FIG. 6 illustrates an example of signaling between peer devices for device pairing, according to some embodiments. The signaling shown in FIG. 6 may be used in conjunction with any of the systems or devices shown in the above Figures, among other devices. In various embodiments, some of the signaling shown may be performed concurrently, in a different order than shown, or may be omitted. Additional signaling may also be performed as desired.

As shown, an initiating device 616 (or initiator 616), which may be a client station 106, may transmit a subscribe service discovery frame (SDF) 634 via a lower layer (e.g., NAN layer 624) in response to receiving a subscribe request 632 from an upper layer (e.g., service or application layer 620). In addition, a responding device 606 (or responder 606), which may also be a client station 106, may receive the subscribe SDF 634 via a lower layer (e.g., NAN layer 614) subsequent to the lower layer of the responding device 606 receiving a publish request message 630 from an upper layer (e.g., service or application layer 610) of the responding device 606. The responding device 606 may respond to the subscribe SDF 634 with a publish SDF 636. In addition, the lower layer of the initiating device 616 may report results (e.g. via message 638) of the discovery to the upper layers of the initiating device 616. Further service discovery 640 may then be performed between the upper layers of the initiating and responding devices and a peer-to-peer data session may be initiated (e.g., via session start message 642 sent from service layer 620 to session layer 622 of initiating device 616).

As shown, once the peer-to-peer data session has been initiated, device pairing 644 may commence with the initiating device 616 obtaining device pairing information via an OOB mechanism as described above. In some embodiments, the session layer 622 may transmit a pairing request 646 to the lower layer (e.g., NAN layer 624) of the initiating device 616. Device pairing messages 648, including the pairing request, may then be exchanged, along with scheduling information, via NAN management frames. The responding device 606 may receive the management frames via the lower layer (e.g., NAN layer 614) and pass the paring request (e.g., via message 650) to a session layer 612 of the responding device 606. The session layer 612 may confirm the pairing request to the lower layer via message 652. Subsequently, the device pairing may be completed at the lower layers (e.g., based on pairing messages 648) and confirmation may be passed from the lower layers to the session layers (e.g., via messages 654 and 656).

Once device pairing has been completed, a secured datapath may be setup via message exchange 658, e.g., via use of a shared secret (or key) and/or authenticated public keys obtained during device pairing as described above. Subsequently, a secured session may be setup via message exchange 660, e.g., via using the authenticated public keys obtained during device pairing as long-term public keys and/or to derive long-term public keys as described above. Once the secured session setup has been confirmed by both devices (e.g., via session confirmation messages 662 and 664), secured data communication may commence at 670.

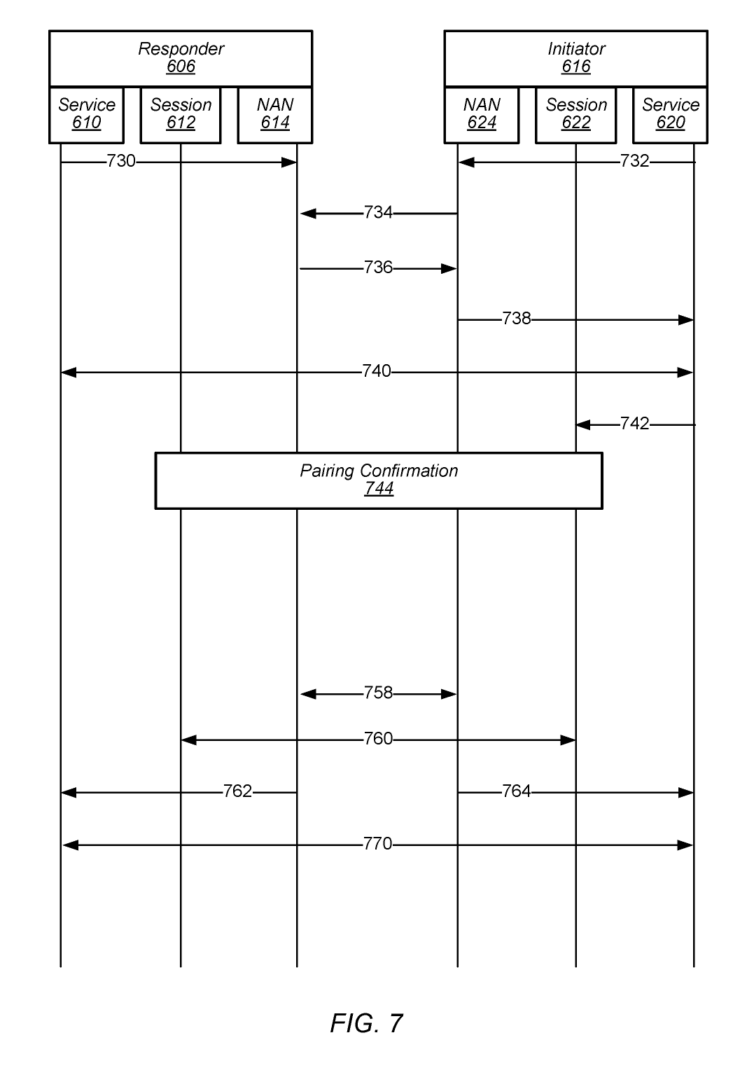

In some embodiments, as illustrated by FIG. 7 and further discussed below, once peer devices have completed device pairing (e.g., obtaining and storing long-term shared key or long-term public keys), the peer devices may skip pairing bootstrapping for future communications (e.g., so long as keys remain valid) and proceed to secured datapath setup and/or secured session setup using the stored long-term key(s). In some embodiments, once the peer devices have completed device pairing and stored the long-term keys, the peer devices may include device identifiers and long-term key identifiers in service discovery messages and/or service discovery beacons to allow peer devices to determine whether there are existing long-term keys between the peer devices. In instances in which the existing long-term keys are still valid, the peer devices may skip device pairing after service discovery.

For example, FIG. 7 illustrates an example of signaling between peer devices for confirming device pairing, according to some embodiments. The signaling shown in FIG. 7 may be used in conjunction with any of the systems or devices shown in the above Figures, among other devices. In various embodiments, some of the signaling shown may be performed concurrently, in a different order than shown, or may be omitted. Additional signaling may also be performed as desired.

As shown, the initiating device 616 (or initiator 616) may transmit a subscribe SDF 734 via the lower layer (e.g., NAN layer 624) in response to receiving a subscribe request 732 from the upper layer (e.g., service or application layer 620). In addition, the responding device 606 (or responder 606 may receive the subscribe SDF 734 via the lower layer (e.g., NAN layer 614) subsequent to the lower layer of the responding device 606 receiving a publish request message 730 from the upper layer (e.g., service or application layer 610) of the responding device 606. The responding device 606 may respond to the subscribe SDF 734 with a publish SDF 736. In some embodiments, the publish SDF 736 may include device identifiers as well as long-term key identifiers. In addition, the lower layer of the initiating device 616 may report results (e.g. via message 738) of the discovery (including the long-term key identifiers) to the upper layers of the initiating device 616. Further service discovery 740 may then be performed between the upper layers of the initiating and responding devices and a peer-to-peer data session may be initiated (e.g., via session start message 742 sent from service layer 620 to session layer 622 of initiating device 616).

At 744, the devices may confirm a device pairing configuration. Thus, each device may confirm that long-term key identifiers (e.g., included in SDF messages exchanged and/or exchanged during further service discovery) remain valid. In some embodiments, if the long-term key identifiers remain valid (e.g., have not expired and/or have not been revoked by one of the devices), the device may determine to skip (e.g., not perform) a device pairing procedure and may proceed to setup of a secured datapath via message exchange 758, e.g., via use of a shared secret (or key, e.g., such as the long-term key exchanged previously) and/or authenticated public keys obtained during previous device pairing as described above. Subsequently, a secured session may be setup via message exchange 760, e.g., via using the authenticated public keys obtained during previous device pairing (and confirmed as still valid) as long-term public keys and/or to derive long-term public keys as described above. Once the secured session setup has been confirmed by both devices (e.g., via session confirmation messages 762 and 764), secured data communication may commence at 770.

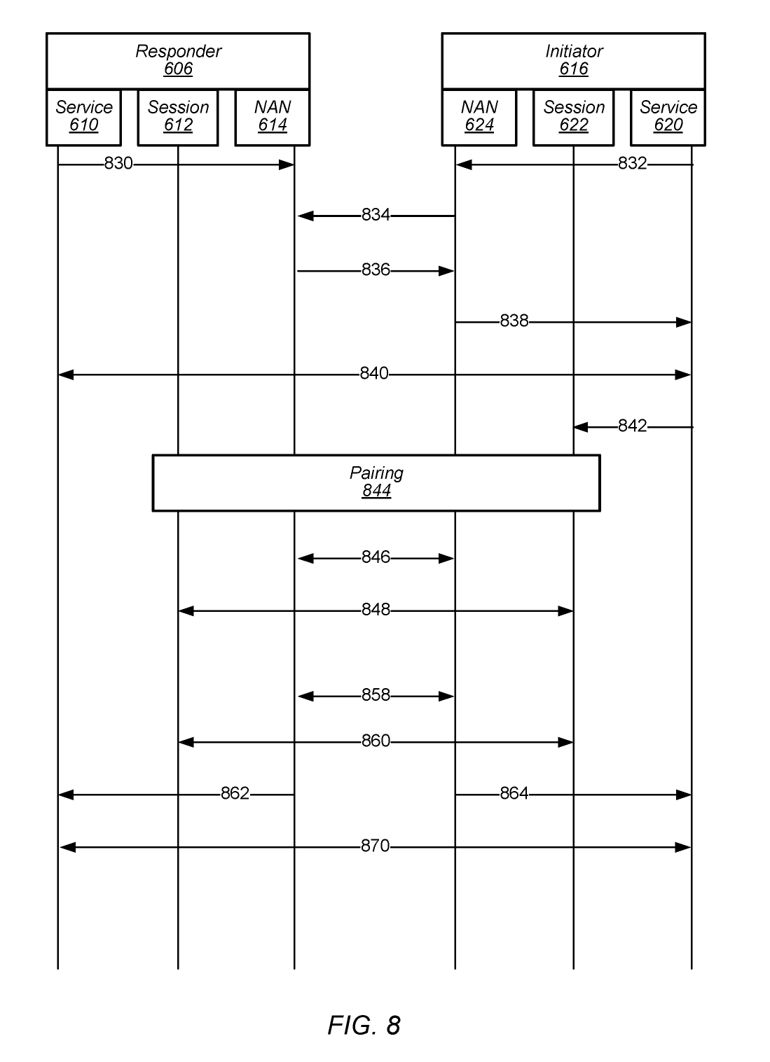

In some embodiments, as illustrated by FIG. 8 and further discussed below, device pairing may be conducted at a session layer instead of lower layers (e.g., NAN layers). As illustrated, in such embodiments, an unsecured NAN datapath may be established to enable device pairing handshaking at the session level, e.g., using HTTP frames. Note that once device pairing is complete, long-term keys may be installed on both peer devices. Further, secured NAN datapath setup and secured session setup may then be conducted using long-term keys (e.g., as described above) generated from the device pairing handshaking at the session level.

In some embodiments, a pseudo-secured NAN datapath may be established between peer devices via implementation of the Diffie-Hellman method based on un-authenticated public keys exchanged between the peer devices. The exchange of un-authenticated public keys and confirmation of a shared secret (e.g., by using the Diffie-Hellman method) can be conducted by using NAN management frames. The un-authenticated shared secret established between the peer devices may be used to derive PMK and PTK for MAC-level data protection. Once the pseudo-secured NAN datapath is established, device pairing handshaking (e.g., as described above) may be conducted at the session layer. Further, successful device pairing at the session layer may authenticate security associations at both the NAN level and the session level. The pseudo-secured NAN datapath is then converted to a secured NAN datapath and session keys may be installed to protect session layer data frames. However, if the device paring at the session layer is unsuccessful, the pseudo-secured NAN datapath may be terminated immediately.

For example, FIG. 8 illustrates an example of signaling between peer devices for device pairing conducted at higher layers, according to some embodiments. The signaling shown in FIG. 8 may be used in conjunction with any of the systems or devices shown in the above Figures, among other devices. In various embodiments, some of the signaling shown may be performed concurrently, in a different order than shown, or may be omitted. Additional signaling may also be performed as desired.

As shown, an initiating device 616 (or initiator 616), which may be a client station 106, may transmit a subscribe service discovery frame (SDF) 834 via a lower layer (e.g., NAN layer 624) in response to receiving a subscribe request 832 from an upper layer (e.g., service or application layer 620). In addition, a responding device 606 (or responder 606), which may also be a client station 106, may receive the subscribe SDF 834 via a lower layer (e.g., NAN layer 614) subsequent to the lower layer of the responding device 606 receiving a publish request message 830 from an upper layer (e.g., service or application layer 610) of the responding device 606. The responding device 606 may respond to the subscribe SDF 834 with a publish SDF 836. In addition, the lower layer of the initiating device 616 may report results (e.g. via message 838) of the discovery to the upper layers of the initiating device 616. Further service discovery 840 may then be performed between the upper layers of the initiating and responding devices and a peer-to-peer data session may be initiated (e.g., via session start message 842 sent from service layer 620 to session layer 622 of initiating device 616).

As shown, once the peer-to-peer data session has been initiated, device pairing 844 may commence with the initiating device 616 obtaining device pairing information via an OOB mechanism as described above. In some embodiments, at 846, the lower layers of the initiating device 616 and the responding device 606 may exchange SDFs to setup an unsecured peer-to-peer data session (e.g., an unsecured NAN datapath). For example, in some embodiments, the unsecured peer-to-peer data session may be established via implementation of the Diffie-Hellman method based on un-authenticated public keys exchanged between the peer devices. In some embodiments, the exchange of un-authenticated public keys and confirmation of a shared secret (e.g., by using the Diffie-Hellman method) can be conducted by using NAN management frames. The un-authenticated shared secret established between the peer devices may be used to derive PMK and PTK for MAC-level data protection. Further, at 848, session layers 622 and 612 may perform a pairing handshake, e.g., via exchange of HTTP frames. Upon completion of pairing handshake, long-term keys may be installed on both devices.

Once device pairing has been completed, a secured datapath may be setup via message exchange 858, e.g., via use of a shared secret (or key) and/or authenticated public keys obtained during device pairing as described above. Subsequently, a secured session may be setup via message exchange 860, e.g., via using the authenticated public keys obtained during device pairing as long-term public keys and/or to derive long-term public keys as described above. Once the secured session setup has been confirmed by both devices (e.g., via session confirmation messages 862 and 864), secured data communication may commence at 870.

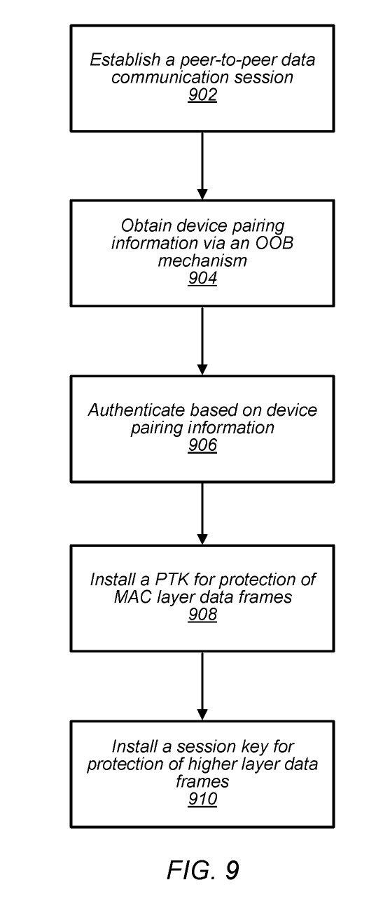

FIG. 9 illustrates a block diagram of an example of a method for peer device pairing, according to some embodiments. The method shown in FIG. 9 may be used in conjunction with any of the systems or devices shown in the above Figures, among other devices. In various embodiments, some of the method elements shown may be performed concurrently, in a different order than shown, or may be omitted. Additional method elements may also be performed as desired. As shown, this method may operate as follows.

At 902, a wireless station (such as client station 106) may establish a peer-to-peer data communication with a peer wireless station. In some embodiments, the peer-to-peer data communication session may be established based on exchange of one or more service discovery frames (SDFs), e.g., as described above. In some embodiments, the peer-to-peer data communication session may be established based on the NAN protocol. In some embodiments, the peer-to-peer data communication session may exchange data via Wi-Fi communications.

At 904, device pairing information may be obtained via an out-of-band (OOB) mechanism. In some embodiments (e.g., as described above), the OOB mechanism may include at least one of (or one or more of) a passcode input, a quick response (QR) code scan, and/or a near field communication (NFC) exchange.

At 906, the peer wireless station may be authenticated based on exchanged device pairing information. The device paring information may be exchanged via one or more management frames. In some embodiments, the one or more management frames may include scheduling information. In some embodiments, the one or more management frames may include (or be) NAN action frames. In some embodiments, the device pairing information may include at least one of (or one or more of) a shared secret, a shared key, and/or public keys.

At 908, a pairwise transient key (PTK) for protection of medium access control (MAC) layer data frame may be installed. In other words, the PTK may protect a data frame (and/or frames) exchanged at the MAC layer of the wireless station. In some embodiments, the PTK may be based, at least in part, on the device pairing information. In some embodiments, a pairwise master key (PMK) based, at least in part, on the device pairing information may be derived and verified in order to install the PTK.

At 910, a session key for protection of higher layer data frame may be installed. In other words, the session key may protect a data frame (and/or frames) exchanged at higher layers of the wireless station. In some embodiments, the session key may be based, at least in part, on the device pairing information.

In some embodiments, an SDF may be received from a second peer wireless station. The SDF may include at least one of (or one or more of) a device identifier and/or a long-term key identifier. In addition, the wireless station may determine based, at least in part, on at least one of (or one or more of) the device identifier and/or the long-term key identifier that the second peer wireless station has previously been authenticated. In some embodiments, the wireless station may establish a secured datapath connection (e.g., a secured peer-to-peer data communication session) based on the second peer wireless station previously being authenticated. In some embodiments, to determine that the second peer wireless station has previously been authenticated, the wireless station may determine that at least one long-term key identified by the second peer wireless station has not expired.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a wireless device (or wireless station) may be configured to include a processor (or a set of processors) and a memory medium, where the memory medium stores program instructions, where the processor is configured to read and execute the program instructions from the memory medium, where the program instructions are executable to cause the wireless device to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A wireless station, comprising:
at least one antenna;
at least one radio in communication with the at least one antenna and configured to perform communications via a Wi-Fi interface; and
at least one processor in communication with the at least one radio;
wherein the at least one processor is configured to cause the wireless station to:
establish, with a peer wireless station, a peer-to-peer data communication session via exchange of one or more service discovery frames;
obtain device pairing information via an out-of-band (OOB) mechanism;
exchange the device pairing information with the peer wireless station via transmission of one or more management frames;
authenticate the peer wireless station based on the exchange of device pairing information;
install a pairwise transient key (PTK), wherein the PTK is based, at least in part, on the device pairing information, wherein the PTK protects a data frame exchanged at a medium access control (MAC) layer of the wireless station; and
install a session key, wherein the session key is based, at least in part, on the device pairing information, and wherein the session key protect a data frame exchanged at one or more higher layers, above the MAC layer, of the wireless station.

2. The wireless station of claim 1,
wherein the OOB mechanism comprises at least one of:
a passcode input;
a quick response (QR) code scan; or
a near field communication (NFC) exchange.

3. The wireless station of claim 1,
wherein the one or more management frames include scheduling information associated with the wireless station.

4. The wireless station of claim 1,
wherein the one or more management frames comprise Neighbor Awareness Networking (NAN) action frames.

5. The wireless station of claim 1,
wherein the device pairing information comprises at least one of:
a shared secret;
a shared key; or
a public key.

6. The wireless station of claim 1,
wherein, to install the PTK, the at least one processor is further configured to cause the wireless station to:
derive a pairwise master key (PMK) based at least in part on the device pairing information; and
verify the PMK.

7. The wireless station of claim 1,
wherein the at least one processor is further configured to cause the wireless station to:
receive a service discovery frame (SDF) from a second peer wireless station, wherein the SDF includes at least one of a device identifier or a long-term key identifier;
determine based on at least one of the device identifier or the long-term key identifier that the second peer wireless station has previously been authenticated; and
establish a secured datapath connection based at least in part on the second peer wireless station previously being authenticated.

8. The wireless station of claim 7,
wherein, to determine that the second peer wireless station has previously been authenticated, the at least one processor is further configured to cause the wireless station to:
determine that at least one long-term key identified by the second peer wireless station has not expired.

9. An apparatus, comprising:
a memory; and
at least one processor in communication with the memory, wherein the at least one processor is configured to:
obtain device pairing information via an out-of-band (OOB) mechanism for securing a peer-to-peer data communication session established with a neighboring wireless station;
authenticate the neighboring wireless station based on an exchange of the device pairing information;
secure a medium access control (MAC) layer connection with the neighboring wireless station via a pairwise transient key (PTK), wherein the PTK is based, at least in part, on the device pairing information; and
secure a higher layer connection with the neighboring wireless station via a session key, wherein the session key is based, at least in part, on the device pairing information.

10. The apparatus of claim 9,
wherein the device pairing information is exchanged via one or more management frames, wherein the one or more management frames comprise scheduling information associated with the apparatus.

11. The apparatus of claim 9,
wherein the device pairing information comprises at least one of:
a shared secret;
a shared key; or
a public key.

12. The apparatus of claim 9,
wherein the PTK is installed and installation of the PTK includes derivation and verification of a pairwise master key (PMK) that is based, at least in part, on the device pairing information.

13. The apparatus of claim 9,
wherein the at lest one processor is further configured to:
receive one or more service discovery frames (SDFs) from a second neighboring wireless station, wherein the one or more SDFs include at least one of a device identifier or a long-term key identifier;
determine based on at least one of the device identifier or the long-term key identifier that the second neighboring wireless station has previously been authenticated; and
establish a secured peer-to-peer data communication based on the second neighboring wireless station previously being authenticated.

14. The apparatus of claim 13,
wherein, to determine that the second neighboring wireless station has previously been authenticated, the at least one processor is further configured to:
determine that at least one long-term key identified by the second peer wireless station has not expired.

15. A non-transitory computer readable memory medium storing program instructions executable by processing circuitry to cause a wireless station to:
exchange one or more service discovery frames (SDFs) to establish a datapath with a peer wireless station, wherein the datapath is not secure;
authenticate the peer wireless station via an exchange of device pairing information, wherein the device pairing information is obtained via an out-of-band (OOB) mechanism;
secure the datapath with the peer wireless station via installation of a pairwise transient key (PTK), wherein the installation of the PTK is based on a derived and verified pairwise master key (PMK) that is based, at least in part, on the device pairing information; and
secure at least one higher layer connection with the peer wireless station via installation of a session key that is based, at least in part, on the device pairing information.

16. The non-transitory computer readable memory medium of claim 15,
wherein the device pairing information is exchanged via one or more management frames, wherein the one or more management frames comprise scheduling information associated with the wireless station.

17. The non-transitory computer readable memory medium of claim 15,
wherein the device pairing information comprises at least one of:
a shared secret;
a shared key; or
a public key.

18. The non-transitory computer readable memory medium of claim 15,
wherein the OOB mechanism comprises at least one of:
a passcode input;
a quick response (QR) code scan; or
a near field communication (NFC) exchange.

19. The non-transitory computer readable memory medium of claim 15,
wherein the program instructions are further executable to:
receive an SDF from a second peer wireless station, wherein the SDF includes at least one of a device identifier or a long-term key identifier;
determine based on at least a portion of the SDF that the second peer wireless station has previously been authenticated; and
establish a secured datapath connection based at least on the second peer wireless station previously being authenticated.

20. The non-transitory computer readable memory medium of claim 19,
wherein the program instructions are further executable to:
secure one or more higher layer connections with the second peer wireless station via installation of a session key that is based, at least in part, on the second peer wireless station previously being authenticated.
